(19) United States
(12) Patent Application Publication
(10) Pub. No.: US 2019/0162560 A1
(43) Pub. Date: May 30, 2019

(54) Brushless DC Motor and Method for Providing an Angle Signal

(71) Applicant: Robert Bosch GmbH, Stuttgart (DE)

(72) Inventors: Fabian Utermoehlen, Leonberg (DE); Stefan Leidich, Rutesheim (DE)

(21) Appl. No.: 16/091,925

(22) PCT Filed: Mar. 8, 2017
(86) PCT No.: PCT/EP2017/055449

§ 371 Date: Oct. 5, 2018

(30) Foreign Application Priority Data
Apr. 21, 2016 (DE) 10 2016 206 768.0

(51) Int. Cl. G01D 5/20; G01D 5/22; H02K 29/12

(52) U.S. Cl. CPC G01D 5/202; H02K 29/12; G01D 5/2225

(57) ABSTRACT

A brushless DC motor configured with an external rotor includes an analysis and control unit, a stator, a rotor, a co-rotating bell, and a sensor that detects an angular position of the rotor. A target with at least one electrically conductive track is attached to the co-rotating bell, and the sensor is configured as an eddy current sensor with at least one coil. The sensor is arranged at a radial distance from the target such that the at least one electrically conductive track at least partly covers the at least one coil. The sensor provides an angle signal as a function of the at least one coil being covered by the at least one electrically conductive track. The angle signal uniquely represents the absolute angular position of the rotor up to 360°. A method includes providing an angle signal for the brushless DC motor.

The invention is based on a brushless DC motor or a method for providing an angle signal according to the genre specified in the independent patent claims.

Brushless DC motors in the form of external rotors with sensor-controlled and sensor-less commutation are known from the prior art. In the sensor-controlled commutation a position of the rotor of the DC motor is measured, for example with optical sensors and/or Hall sensors, in order to activate the phases of a stator accordingly. This allows a virtually “judder-free” startup of the DC motor. The use of magnetic sensors suggests the dual use of the magnets of the permanent excitation as the sensor magnet. Since in the normal case only two windings of the at least three-phase stator system are ever activated, the rotor position in the case of sensor-less commutation is determined by the voltage induced in the stator winding that is currently not activated. This signal is only available when the rotor is in motion, however. The sensor-less startup is therefore particularly critical. Often, the motor is started with a fixed cycle pattern. Due to the uncertainty of the initial rotor positions this can lead to intense juddering. This behavior is not acceptable for a wide variety of applications.

Furthermore, servo drives with brushless DC motors for throttle valves or similar systems are known from the prior art, the position of which is varied using a speed-reducing transmission. Here, in addition to the rotor position for the motor control, the position of the output is detected as a functional aspect. This requires a second sensor, because the translation would require a plurality of (electrical/mechanical) revolutions to be distinguished. The use of the sensor on the output for the motor control is problematic, because the gear backlash can lead to comparatively large angular errors in determining the rotor position. By using motors with a large number of electrical poles, the mechanical translation can be partially eliminated (direct drive). In the sensor-less operation and with the use of magnetic sensors and dual use of the permanent-magnet excitation, the electrical phase position does not correspond to the absolute position of the motor shaft.

For example, EP 0856 720 A1 discloses a steering angle sensor for detecting the rotation angle or a change of rotation angle of the steering wheel of a motor vehicle, in which an electrical signal is generated by means of an electro-mechanical component, said signal being dependent on the rotation angle or rotation angle change. A contactless steering angle sensor consists of a permanent magnet attached to the end of a steering spindle, the magnetization axis of which is perpendicular to the axis of the steering spindle. In the area of the permanent magnet a magnetic field-sensitive sensor is located, which preferably consists of Hall elements in discrete or integrated form.

### DISCLOSURE OF THE INVENTION

The brushless DC motor with the features of independent claim 1 and the method for providing an angle signal with the features of the independent claim 7 have the advantage that by exploiting the co-rotating bell of the brushless DC motor to perform the absolute angle determination of the rotor by means of an eddy current sensor, both a cost reduction and an overall space reduction are achieved. The sensor delivers a measurement signal with a unique value up to 360°, regardless of the number of pole pairs of the brushless DC motor. The measurement signal can be used, for example, for the commutation of the stator coils, which is essential in particular for jerk-free starting in actual electric vehicles. In applications which are able to eliminate a mechanical translation by the use of appropriately high-torque motors, in addition to the motor control, the sensor can also be used for regulating the output or the usage function. It is therefore possible to dispense with a second sensor.

Embodiments of the present invention provide a brushless DC motor as an external rotor, which motor comprises a stator, a rotor, a co-rotating bell and a sensor, which detects an angular position of the rotor. A target with at least one electrically conductive track is attached to the co-rotating bell, and the sensor is designed as an eddy current sensor with at least one coil, wherein the sensor is arranged at a radial distance from the target such that the at least one electrically conductive track at least partially overlaps the at least one coil, wherein the sensor provides an angle signal as a function of the degree of overlap of the at least one coil by the at least one electrically conductive track, said angle signal uniquely representing the absolute angular position of the rotor up to 360°.

In addition, a method for providing an angle signal is proposed, which represents an angular position of a rotor of a brushless DC motor, wherein the DC motor is implemented as an external rotor with a co-rotating bell. In this case, the angle signal is generated as a function of the degree of overlap of at least one coil of a sensor, implemented as an eddy current sensor, by at least one electrically conductive track of a target which is attached to the co-rotating bell, wherein the angle signal uniquely represents the absolute angular position of the rotor angle up to 360°.

The core of the invention is the mounting of an electrically conductive track on the co-rotating bell of the brushless DC motor, the application of a corresponding eddy current sensor for measuring the absolute angular position and the provision of an angle signal which represents the absolute angular position. The angle signal can be used for commutation of the stator coils and/or for regulating the output.

Embodiments of the invention require less additional space in comparison to shaft end sensors, which increase the length of the DC motor. Due to the unique determination of the absolute angular position of the rotor in the range up to 360°, additional sensors on the driven assemblies, such as valves etc., can be eliminated. In addition, due to the implementation of the eddy current principle, a robust measurement with regard to EMC is possible, which is insensitive to static magnetic fields and motor currents. The angle signal that is provided also results in a better regulation of the commutation compared to sensor-less methods.

The analysis and control unit in the present case can be understood to mean an electrical device, such as a control unit, in particular a motor control unit which processes and/or evaluates detected sensor signals. The analysis and control unit can have at least one interface, which can be implemented in hardware and/or software. In the case of a hardware-based design, the interfaces can be, for example, part of a so-called system-ASIC, which includes the wide range of functions of the analysis and control unit. It is also possible, however, that the interfaces are dedicated integrated circuits, or at least in part consist of discrete components. In the case of a software-based design, the interfaces can be software modules which exist, for example, on a micro-controller in addition to other software modules. Also advantageous is a computer program product with program code, which is stored on a machine-readable medium such as a semiconductor memory, a hard drive or an optical memory, and is used to perform the analysis when the program is executed by the analysis and control unit.

In the present case, a sensor is understood to mean a component which comprises at least one sensor element, which directly or indirectly senses a physical parameter or a change in a physical parameter and preferably converts it into an electrical sensor signal.

The measures and extensions listed in the dependent claims enable advantageous improvements of the brushless DC motor specified in independent claim 1 and the method for providing an angle signal specified in independent claim 7.

It is particularly advantageous that a thickness and/or a width of the at least one electrically conductive track can vary over a 360° circuit, in order to facilitate the measurement.

In an advantageous design of the DC motor, the sensor can generate the angle signal by measuring the inductance of the at least one coil as a function of the degree of overlap by the at least one electrically conductive track. The at least one coil generates eddy currents in the at least one electrically conductive track, which generate an angle-dependent change in the inductance of the at least one coil. This inductance change can be determined in the analysis and control unit using, for example, an LC-oscillator circuit with frequency counter, or by measuring the decay time of an LR circuit. Alternatively, the sensor can generate the angle signal via an inductive coupling between at least two coils as a function of the degree of overlap by the at least one electrically conductive track. The alternative evaluation concept can exploit the coupling between two sensor coils, in a similar way to a transformer, while they are simultaneously overlapped by the at least one electrically conductive track.

In another advantageous design of the DC motor, the analysis and control unit can use the angle signal for the commutation of stator coils and/or for output regulation. In addition, the analysis and control unit can output the angle signal to other vehicle systems and/or vehicle functions.

In an advantageous design of the method for providing an angle signal, the angle signal can be generated by measuring the inductance of the at least one coil as a function of the degree of overlap by the at least one electrically conductive track. Alternatively, the angle signal can be generated via an inductive coupling between at least two coils as a function of the degree of overlap by the at least one electrically conductive track.

In another advantageous configuration of the method for providing an angle signal, the angle signal can be used for the commutation of stator coils of the brushless DC motor and/or for the output regulation of the brushless DC motor and/or be output to other vehicle systems and/or vehicle functions.

Exemplary embodiments of the invention are shown in the drawing and are explained in more detail in the following description. In the drawing, the same reference numbers denote the same components or elements which perform identical or similar functions.

### BRIEF DESCRIPTION OF THE DRAWINGS

FIG. 1 shows a schematic representation of an exemplary embodiment of a brushless DC motor according to the invention as an external rotor.

FIG. 2 shows a schematic representation of a first exemplary embodiment of an unwound target, which is attached to a co-rotating bell of the brushless DC motor of FIG. 1.

FIG. 3 shows a schematic representation of a second exemplary embodiment of an unwound target, which is attached to a co-rotating bell of the brushless DC motor of FIG. 1.

FIG. 4 shows a schematic representation of a third exemplary embodiment of an unwound target, which is attached to a co-rotating bell of the brushless DC motor of FIG. 1.

### EMBODIMENTS OF THE INVENTION

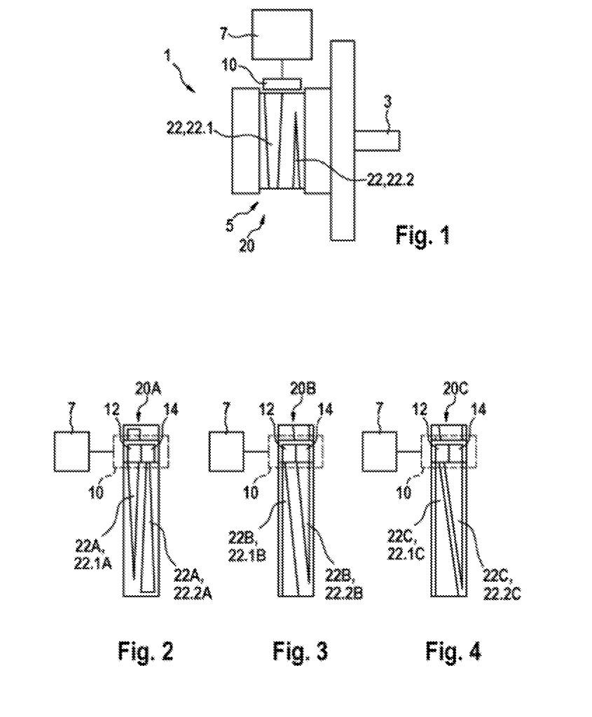

As can be seen from FIGS. 1 to 4, the exemplary embodiment shown of a brushless DC motor 1 according to the invention as an external rotor comprises an analysis and control unit 7, a stator which is not shown in detail, a rotor not shown in detail, a co-rotating bell 5 and a sensor 10 which determines an angular position of the rotor. In the arrangement, a target 20, 20A, 20B, 20C with at least one electrically conductive track 22, 22A, 22B, 22C is attached to the co-rotating bell 5 and the sensor 10 is implemented as an eddy current sensor with at least one coil 12, 14. The sensor 10 is arranged at a radial distance from the target 20, 20A, 20B, 20C, such that the at least one electrically conductive track 22, 22A, 22B, 22C at least partially overlaps the at least one coil 12, 14, wherein the sensor 10 provides an angle signal as a function of the degree of overlap of the at least one coil 12, 14 by the at least one electrically conductive track 22, 22A, 22B, 22C, said angle signal uniquely representing the absolute angular position of the rotor up to 360°.

In principle, to operate the brushless DC motor 1 the analysis and control unit 7 activates at least three coils of the stator in such a way that a rotating magnetic field is produced, which drives a usually permanent-magnet excited rotor (permanent-magnet synchronous motor). For this purpose, two coils are usually activated at the same time and the third is de-energized. To identify which two coils have the desired torque effect on the rotor, the rotor position is determined. In other DC motors known from the prior art the rotor position is implemented for example using Hall sensors, optical sensors or in a sensor-less manner via the evaluation of the voltage induced in the unused coil. The sensor-less design is usually only used in applications in which low start-up torque is needed and in which a smooth start-up of the engine is not absolutely necessary, such as when driving propellers. For applications which are connected to such a brushless DC motor via a transmission, in most cases, a direct measurement of the rotor position is carried out. Most of the DC motors use a number of pole pairs Np which is greater than 1 (typically 4 to 12). The electrical activation thus commutates four or twelve times within one mechanical revolution. The determination of the angular position of the rotor with a uniqueness range of 360° allows the calculation of the electrical phase position φ(e) by modulo division according to the following equation (1).

φ(e)=Mod(φ(abs),360°/Np) (1)

where φ(abs) represents the absolute angular position of the rotor and Np the number of pole pairs.

A sensor with a smaller uniqueness range or a sensor-less determination of the rotor position does not allow extrapolation to the absolute position of the rotor or the output. It is therefore not possible to use the rotor position signal for regulating the output, even in the case of direct drives without a transmission.

Embodiments of the present invention exploit the co-rotating bell 5 of the brushless DC motor 1 to function as an external rotor, so that a measurement of the absolute angular position with a uniqueness range of 360° is achieved. For this purpose, a target 20, 20A, 20B, 20C made of a conductive material is moved past the sensor 10, implemented as an eddy current sensor, and generates an angle-dependent change in the inductance of the at least one sensor coil 12, 14. This can be determined in the analysis and control unit 7 using, for example, an LC-oscillator circuit with frequency counter, or by measuring the decay time of an LR circuit. In the exemplary embodiments depicted, the target 20, 20A, 20B, 20C forms a cylindrical outer surface which is attached to the outside of the bell 5, and in each case comprises two electrically conductive tracks 22, 22A, 22B, 22C which at least partially overlap the at least one coil 12, 14 depending on the angular position of the rotor or the co-rotating bell 5. As an alternative evaluation concept, the coupling between two sensor coils 12, 14 while they are simultaneously overlapped by the target 20, 20A, 20B, 20C could also be determined.

As is also apparent from FIGS. 1 to 4, a thickness and/or a width of the at least one electrically conductive track 22, 22A, 22B, 22C varies over a circuit of 360°. In the depicted exemplary embodiments, each target 20, 20A, 20B, 20C has two electrically conductive tracks 22, 22A, 22B, 22C isolated from each other. In each case a first electrically conductive track 22.1, 22.1A, 22.1B, 22.1C extends on the left-hand lateral edge of the cylindrical outer surface of the target 20, 20A, 20B, 20C and a second electrically conductive track 22.2, 22.2A, 22.2B, 22.2C extends on the right-hand lateral edge of the cylindrical outer surface of the target 20, 20A, 20B, 20C.

As is also apparent from FIG. 1, in the first exemplary embodiment shown of the target 20 the width of the first track 22.1 decreases from top to bottom and the width of the second track 22.2 increases from top to bottom.

As is further apparent from FIG. 2, the electrical tracks 22A in the second exemplary embodiment shown of the target 20A each have the shape of an isosceles triangle, wherein the width of the first track 22.1A decreases from top to bottom and the width of the second track 22.2A increases from top to bottom.

As is further apparent from FIG. 3, the electrical tracks 22B in the third exemplary embodiment shown of the target 20B each have the shape of an isosceles triangle, wherein the width of the first track 22.1B increases from top to bottom and the width of the second track 22.2B decreases from top to bottom.

As is further apparent from FIG. 4, the electrical tracks 22C in the fourth exemplary embodiment shown of the target 20C, in a similar way to the third exemplary embodiment, each have the shape of a right-angled triangle, wherein the triangular faces of the electrical tracks 22C in the fourth exemplary embodiment are larger than in the third exemplary embodiment. In this case the width of the first track 22.1C increases from top to bottom and the width of the second track 22.2C decreases from top to bottom.

As is also apparent from FIGS. 2 to 4, the sensor 10 in the exemplary embodiments shown comprises two coils 12, 14 arranged adjacent to each other, so that the sensor generates the angle signal by measuring the inductances of the two coils 12, 14 as a function of the degree of overlap by the at least one electrically conductive track 22, 22A, 22B, 22C.

Embodiments of the method according to the invention for providing an angle signal which represents an angular position of a rotor of a brushless DC motor 1, wherein the DC motor 1 is designed as an external rotor with a co-rotating bell 5, generate the angle signal as a function of the degree of overlap of at least one coil 12, 14 of a sensor 10, implemented as an eddy current sensor, by at least one electrically conductive track 22, 22A, 22B, 22C of a target 20, 20A, 20B, 20C which is attached to the co-rotating bell 5, wherein the angle signal uniquely represents the absolute angular position of the rotor up to 360°. In the illustrated exemplary embodiments, the angle signal is generated by measuring the inductance of the at least one coil 12, 14 as a function of the degree of overlap by the at least one electrically conductive track 22, 22A, 22B, 22C.

This method can be implemented, for example in software or hardware or in a combination of software and hardware, in the analysis and control unit 7, for example. The analysis and control unit 7 can use the angle signal for commutation of stator coils of the brushless DC motor 1 and/or for the output regulation of the brushless DC motor 1 and/or output to other vehicle systems and/or vehicle functions.

1. A brushless DC motor as an external rotor, comprising:
an analysis and control unit,
a stator,
a rotor,
a co-rotating bell, and
a sensor that detects an angular position of the rotor, the sensor configured as an eddy current sensor with at least one coil,
wherein a target with at least one electrically conductive track is attached to the co-rotating bell,
wherein the sensor is arranged at a radial distance from the target such that the at least one electrically conductive track at least partially overlaps the at least one coil, and
wherein the sensor provides an angle signal as a function of the degree of overlap of the at least one coil by the at least one electrically conductive track, the angle signal uniquely representing the absolute angular position of the rotor up to 360°.

2. The DC motor as claimed in claim 1, wherein one or more of a thickness and a width of the at least one electrically conductive track varies over a circuit of 360°.

3. The DC motor as claimed in claim 1, wherein the sensor generates the angle signal by measuring the inductance of the at least one coil as a function of the degree of overlap by the at least one electrically conductive track.

4. The DC motor as claimed in claim 1, wherein the sensor generates the angle signal using an inductive coupling between at least two coils as a function of the degree of overlap by the at least one electrically conductive track.

5. The DC motor as claimed in claim 1, wherein the analysis and control unit uses the angle signal for one or more of the commutation of stator coils and output regulation.

6. The DC motor as claimed in claim 1, wherein the analysis and control unit outputs the angle signal to one or more of other vehicle systems and vehicle functions.

7. A method for providing an angle signal which represents an angular position of a rotor of a brushless DC motor implemented as an external rotor, the DC motor including an analysis and control unit, a stator, a rotor, a co-rotating bell, and a sensor that detects an angular position of the rotor, the sensor configured as an eddy current sensor, the method comprising:
attaching a target with at least one electrically conductive track to the co-rotating bell, and
generating the angle signal as a function of the degree of overlap of at least one coil of the sensor by the at least one electrically conductive track of the target, wherein the angle signal uniquely represents the absolute angular position of the rotor up to 360°.

8. The method as claimed in claim 7, wherein the angle signal is generated by measuring the inductance of the at least one coil as a function of the degree of overlap by the at least one electrically conductive track.

9. The method as claimed in claim 7, wherein the angle signal is generated via an inductive coupling between at least two coils as a function of the degree of overlap by the at least one electrically conductive track.

10. The method as claimed in claim 7, wherein the angle signal is one or more of (i) used for the commutation of stator coils of the brushless DC motor and/or for the output regulation of the brushless DC motor and (ii) output to other vehicle systems and/or vehicle functions.
